(19) United States
(12) Patent Application Publication
(10) Pub. No.: US 2003/0065544 A1
(43) Pub. Date: Apr. 3, 2003

(54) Method and system for performing dynamic scheduling

(76) Inventors: C. Bret Elzinga, Springville, UT (US); Keith Borrowman, Provo, UT (US); Jacob Anderson, Orem, UT (US); David John Dewey, Orem, UT (US); Dale Rowley, Provo, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/966,655

(22) Filed: Sep. 28, 2001

(51) Int. Cl. G06F 17/60

(52) U.S. Cl. 705/8; 345/963

(57) ABSTRACT

A computerized system and method for optimizing a schedule that is filled with a plurality of events are disclosed. The system comprises means for defining a framework to serve as the schedule and means for determining an optimization value. The means for defining a framework populates the framework with the plurality of events, selected of the plurality of events being immutable. The means for determining an optimization value makes its determination based on the placement of the plurality of events after placement of the immutable events and it also determines whether the optimization value achieves a threshold best-solution value. If the threshold value is not reached, the framework defining means will what iperform event swapping to improve the optimization value.

### BACKGROUND

1. Field of Invention

The present invention relates generally to automated scheduling systems. More particularly, the present invention relates to a method and system for performing scheduling that evaluates specific criteria in determining a “best solution” schedule using iterative evaluations.

2. Background

Planning and generating a schedule for work or school are well know in the art. Often, scheduling is necessary to organize work schedules, academic schedules, training schedules, and building schedules. The scheduling is done to optimize available resources such as meeting rooms, instructors, eating facilities, time off, equipment, manpower, and the like. Scheduling systems typically acquire information in the form of resources available, personnel, training required, equipment, among others, along with particular deadlines and priorities that must be performed in order to provide training or complete the task at hand.

Initially, one person would take pen and paper and merely search through the requirements and resources available and define the tasks needed to be accomplished and arrange these elements in an order of completion. Time lines would be used as well to highlight individual tasks in chronological order and priority for completion in preparing a work or academic schedule. As the tasks became more complex, the scheduling techniques typically proved inefficient but were sufficient for the task at hand.

Computers came along and provided a way of greatly simplifying the process of generating and preparing schedules. This automation would take into account the resources available, the time frame in which the project needed to be completed, selected events that are mandatory, as well as conflicts, personnel requirements and availability, and testing or review when completing such a schedule.

Often, the scheduling programs provide and improve the schedule upon multiple runs or durations. The scheduling program continues until a point of diminishing return is reached, in which case further improvements do not justify the additional time necessary to achieve such improvements.

The present invention improves upon the prior art in that it defines particular constraints that are necessary in improving the quality of the schedule. More specifically, penalties are assigned to particular events to be scheduled based on either actual conflicts, prerequisites necessary, repeat offerings, etc. in an attempt to provide a best-solution schedule.

### SUMMARY OF THE INVENTION

According to the present invention, a computerized system and a method for optimizing a schedule that is filled with a plurality of events are disclosed. The system comprises means for defining a framework to serve as the schedule and means for determining an optimization value. The means for defining a framework populates the framework with the plurality of blocks or event holders selected of the plurality of events being immutable. The means for determining an optimization value makes its determination based on the placement of the plurality of events after placement of the immutable events and it also determines whether the optimization value achieves a threshold best-solution value. If the threshold value is not reached, the framework defining means can also perform event swapping to improve the optimization value.

Acceptable solutions to scheduling problems are based on feedback given to the operator from the system so that flaws can be resolved through operator input. The acceptance of a best solution can also be based on conditions established by the operator within the system for resolving particular conflicts or flaws. The adequacy of a solution generated by the system is based on several criteria, including: filling allotted framework time, duration of event, adherence to relationships, adherence to delays, omitting events, specific time, frequency, rotation between shifts, and mutual exclusion. Each one of these criteria will be described in greater detail below.

The system does comparisons of possible filled-schedules and selects a solution that best fulfills the intent of the curriculum. This operates in an iterative process of establishing a first schedule and reviewing whether that schedule falls within the parameters necessary to qualify as the “best solution.”

Using scheduling iteration performed in accordance with the present invention, the scheduling system continues to find better and better solutions until the best solution is eventually achieved. Although it is the intent of the system to provide the most optimal solution possible, due to complexities of scheduling events and resources as well as the speed at which the system actually operates, there is a cut-off point that qualifies as the “best solution.” Even though further refinement may be possible, re-evaluating after this point provides only diminishing returns.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a flow diagram of the scheduling process in accordance with the present invention.

FIG. 2 illustrates a flow diagram of the annealing process.

FIG. 3 illustrates a populated schedule as achieved in accordance with the present invention.

FIG. 4 illustrates a flow diagram of the user's interaction with the system to generate an optimal schedule.

### DETAILED DESCRIPTION OF SPECIFIC EMBODIMENTS

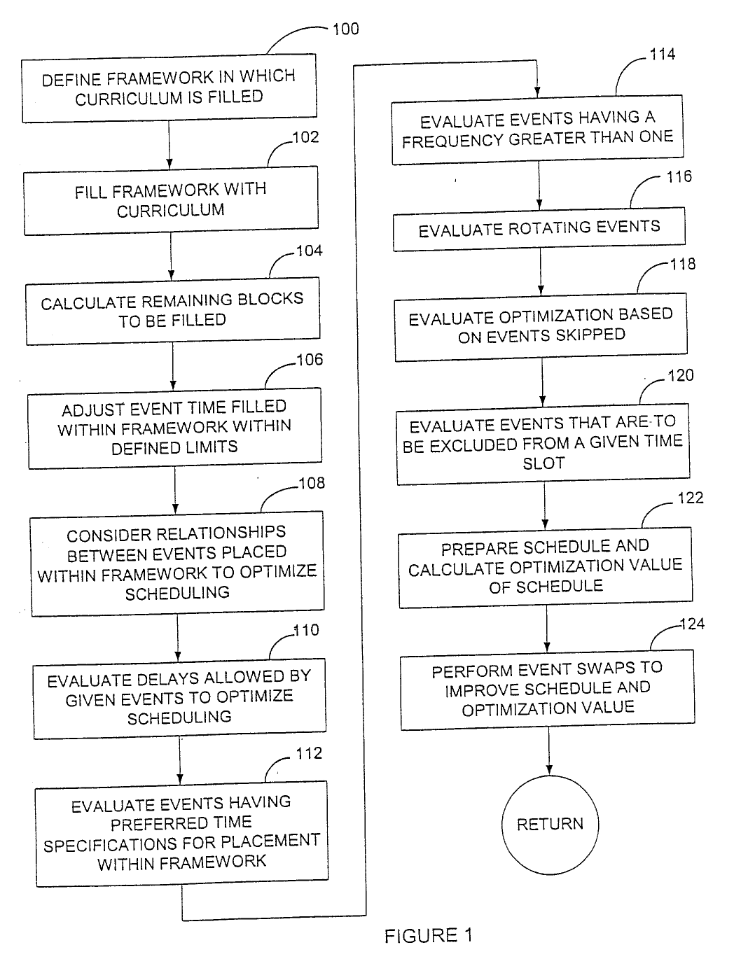

It will be readily understood that the components of the present invention, as generally described and illustrated in the figures herein, could be arranged and designed in a wide variety of different configurations. Thus, the following more detailed description of the embodiments of the system and method of the present invention, and represented in FIGS. 1-4, are not intended to limit the scope of the invention, as claimed, but is merely representative of embodiments of the invention.

The specific embodiments of the invention will be best understood by reference to the drawings, wherein like parts are designated by like numerals throughout.

A scheduling system and method are presented in accordance with the present invention. Preparing a schedule of events for a sophisticated entity requires much input from different resources. These entities typically include school environments, work environments, government environments, and even home environments. Both public and private sectors have a need for and benefit from the improved scheduling system and method found in the present scheduling invention. Further still, the scheduling system and method typically operate under the input of more than one individual in preparing the schedule. It should be understood that one individual can perform the scheduling of all events, but often that individual still requires input from other individuals regarding those events that need to be scheduled by those other individuals. For example, an office complex or learning center would need to schedule building facilities among all participants desiring access to rooms, conference centers, dining facilities and the like in a coordinated and orderly fashion. This coordination prevents conflicts of scheduling so that no group is left out of using the facilities, even though not all will be granted the time slot requested or the desired amount of time requested. Further still, certain types of schedules within work, school, or other sectors are optimized to follow along eating schedules and sleeping schedules to maximize either education or work productivity. The schedule preparer typically has these issues in mind when laying out a schedule.

Performing scheduling can be very time consuming, especially when there are many facilities, many users, and many participants to be coordinated within the schedule. Thus, the ability to automate the scheduling process by use of a computer system provides a great advantage over continually performing scheduling by hand and through notes. The computer automated system can typically find conflicts that are often overlooked due to operator error in a manual system and alerts the scheduler of such conflicts so that they may be resolved or the system directly resolves the conflicts in such a manner so that the operator need not even know of the conflict.

One sophisticated example involves a training or instructional environment that manages the participants within the instructional environment on a full time basis. The full time scheduling includes providing meals, allowing personal time and physical activity, scheduling class attendance, and subject review. Among other things, the curriculum and other activities used to fill in the schedule can result in nearly an infinite number of possible filled-schedules. The method and system in accordance with the present invention optimizes the scheduling to provide what is considered the “best solution” for the events to be scheduled and the facilities to be used. The system does comparisons of possible filled-schedules and selects a solution that best fulfills the intent of the curriculum. This operates in an iterative process of establishing a first schedule and reviewing whether that schedule falls within the parameters necessary to qualify as the “best solution.”

Using scheduling iteration performed in accordance with the present invention, the scheduling system continues to find better and better solutions until the best solution is eventually achieved.

The present invention operates within a computer environment. The computer environment may be a single computer system, such as a personal computer, or can be a network-based system having data stores accessible by each networked-computer participant. The computer system, whether singular or in a network environment, includes processing ability that is programmable by loaded software, such as would be constituted by the present invention. The processor typically accesses memory stores, both long term and short term, to run the software. The computer system typically also includes input means, such as a keyboard or a pointing device, display means, such as a monitor or printer, and other useful and needed accessories typically provided in a computer system.

In the network environment, a plurality of computers would communicate with one another via standard protocols well known to those skilled in the art and would be interconnected in a suitable fashion for such communication. This connection would provide E-mail capability and resource sharing, which would include printers, scanners, and central data stores, among other things.

To aid in an understanding of the invention and its implementation, a list of terms that are commonly used will be described. The examples given below to illustrate working embodiments of the present invention are taken from an educational training framework for teaching groups of individuals new information and a new foreign language(s), and to provide the individuals with review time, time to partake of meals, and personal time. Thus, the definitions will make reference to such educational and training situations, but should not be construed so as to be so limited as the present invention can also be applicable to non-educational or training endeavors such as work scheduling, construction scheduling, or travel scheduling, by way of example.

A framework is a schedule where students or participants are to be at any given time. A framework does not necessarily include curriculum.

A schedule is the result of taking a framework and filling it in or populating it with curriculum.

An event is defined as a combination of an activity and an item. An example of an item would be a specific topic of study, such as teaching a particular grammar principle within a new language. An example of an activity would be in-class practice of the topic found within the event. Thus, practicing the new grammar principle in class would define the event.

Item types are general categories into which items are organized. For example, item types include grammar, concepts, or course material read. Thus, the review of particular grammar principles would be defined as an item, this item is categorized into the item type grammar.

Activity sequence is defined as a sequence of activities and delays and may also be referred to as a track. A delay is either a specific or a range of time to wait before continuing with the next activity.

Anchor points are elements used in creating the schedules from frameworks. Anchor points are created when the user places any event on a certain day in the schedule and when the system then creates the schedule, it treats the anchor points as immutable events.

A base is a set of curriculum that can be used in several organizations. For example, an instructor may create a standard base, which includes topics and resources for use in that base. Once the base is saved, it maybe used by anyone so selecting that particular base. Multiple bases are possible.

Criteria are used to define when and how often a given item type should be studied by the students or participants.

Organization is defined as a complete set of curriculum. This includes bases, any items defined within the organization, the placement of anchor points for each framework, and then the filled schedules for each framework.

Relationships define the sequence of the items that are to be studied by the participants or students. All relationships can be defined as either a pre- or post-requisite relationship. An example of a pre- or post-requisite relationship is found within the item type grammar. To understand and learn the grammar of a new language, the student must study the alphabet before verbs can be studied. The alphabet is a pre-requisite of verbs and verbs are a post-requisite of studying the alphabet.

Relationships are also defined as being either direct or indirect. A direct relationship is an explicit relationship between any two items. An indirect relationship is implicit, or in other words, two items may be indirectly related if they both have a relationship with a third item. To contrast direct versus indirect relationships, the alphabet and verb example is helpful. Alphabet and verbs are two items that are directly related. The verbs may also be directly related to present tense grammar study, such that verbs are a prerequisite of present tense. The alphabet and present tense have no direct relationship, but indirectly, the alphabet is a prerequisite of present tense. Thus, alphabet and present tense are indirectly related.

A report category is used to report where the participants' or students' time is spent. Report categories are used when defining item types.

Acceptable solutions to scheduling problems are based on feedback given to the operator from the system so that flaws can be resolved through operator input. The acceptance of a best solution can also be based on conditions established by the operator within the system for resolving particular conflicts or flaws. The adequacy of a solution generated by the system is based on several criteria, including: filling allotted framework time, duration of event, adherence to relationships, adherence to delays, skipping events, specific time, frequency, rotation between shifts, and mutual exclusion. Each one of these criteria will be described in greater detail below.

The first of the criteria is that of filling the allotted framework time. Activities and events are added to the schedule framework. As the activities and events are added to the framework, not all the time for a particular shift or day will be consumed or occupied. Thus, there will be space left over at the end of each shift or day, due to the fact that there are five minutes left over from one shift, another five minutes from another shift, ten minutes from yet another, such that an accumulation of unused time occurs. This extra time means that at the end of the schedule, there may be one event that cannot fit into the scheduled framework. Time left over at the end of a shift is determined by subtracting the maximum duration of the events from the total amount of time for the shift. Thus, for each minute of extra time, a penalty is to be incurred. In one exemplary embodiment, one minute of access time equates to one point of penalty value. The penalty values are added up and used in determining whether the schedule achieves a “best solution” within the parameters originally established by the scheduler. As the class blocks within the schedule are filled, the sum of the events for each block is then subtracted from the total block time to determine the final excess time. To aid in the understanding of the operation of the scheduling system and method, reference is made to the flow diagram illustrated in FIG. 1.

FIG. 1 depicts the steps typically followed in determining an optimal schedule in accordance with the present invention. Thus, in step 100, the framework is initially defined in which the curriculum is to be filled. It should be noted that the curriculum comprises particular activities, events, tasks, meetings, free time, among others desired to be scheduled during a set period. Next, in step 102, the operator begins to fill the framework with the given curriculum. It is at step 104 that the system then calculates the remaining blocks to be filled in accordance with the filling allotted framework time criterion as previously mentioned.

The next criterion is the duration-of-event criterion. As the framework or schedule is filled, at times it becomes necessary to shorten some events beyond the specified minimum time for that particular event so that all events can fit into a given shift or schedule. Specific rules are given for managing when an event can be shortened. For example, each event can be shortened only so much; otherwise, the time allocated for that particular event would not be sufficient for conveying the information or giving the participants enough time to participate adequately in that selected event. Thus, the system requires that each event has a minimum time requirement beyond which no reduction is granted. This can be a simple minimum time requirement. This minimum time requirement can be specified by the scheduler when entering the event into the framework. When an event has to be shortened from its minimum time, a penalty can be assessed, if acceptable to the operator. The penalty can be based on the percent that that event has varied from its recommended time, or the penalty may be based on how much time is removed from the minimum time threshold as well. In either event, the system, as shown in FIG. 106, adjusts the event time filled within the framework as defined by these particular limits.

When time blocks are filled with selected events, and a particular event almost fits within the block, other events may be shortened to their minimum time in order to accommodate the block that does not fit completely. If, after the readjustment has been performed, the event fits within the schedule, the system is satisfied and it moves on to the next scheduling issue. If the event does not fit at this time, the system proceeds to the next scheduling block by placing that event in a new block. In either event, the system operates so as to prevent violations of conflicts of schedule as best possible in its attempt to arrive at the optimal or best schedule.

The next criterion used in the scheduling system is that of adhering to defined relationships. Relationships are defined by the operator and are used to determine the flow of the schedule from one topic to its logical successor. If, for any reason, there is a break in this relational order, then the solution requires a penalty based on the number of descendant events elapsed before the pre-requisite is accomplished. Thus, in step 108, the system considers these relationships or the relationships between events placed within the framework in its attempt to optimize the scheduling of all events.

There are both inter- and intra-item relationships between the events in the schedule. In checking relationships, only the direct predecessors will be verified. Thus, a table of predecessors is provided as well as a table listing which events have been completed. As the schedule is evaluated, the system evaluates for each event whether the event's predecessor(s) was scheduled prior to the event and not out of order. If such an event was found to be out of order, a table of the number of descendants for that event is utilized to help determine the penalty to be assessed. This penalty can be defined to be event specific so as to determine which events should be used to reschedule conflicts or assess penalties for out of prerequisite scheduling.

The next criterion is that of adhering to delays required between specific events. When a delay is specified between events, that delay should be honored as closely as possible. If a specified delay is not exactly kept, then the percent that it was missed becomes the base for the penalty. For example, if a delay spanning one week is designed to occur between the introduction of one subject and the introduction of a second subject, then altering that delay by a week would incur a one-hundred percent penalty, while missing by a shift would incur only a six percent penalty. Thus, the system, as shown in step 110, evaluates delays allowed by given events for optimizing the schedule. It should be noted that penalty delays can be defined by the user as being important, very important, unimportant, or tolerable. Typically, however, delays are based on days and down, and they are to be checked only on the base for which they are specified.

For example, if a user specifies that strictly no delays should occur between events, then the penalty will be based on the number of minutes between the two events rather than the number of days. Delays also are kept track of as a delay prior to each activity. When the system checks for an event's predecessor, it will also check to see that its predecessor is in conformance with the required delay. If not, another penalty will incur, failing to accommodate delays results in event-specific penalties in accordance with the present invention.

The next criterion is events required to be skipped in order to complete the schedule. As a schedule is filled, it is possible that there is not space available to fit all of the events into the framework. If an event is dropped, this detracts from the desirability of the solution. Skipping an event need not be a binary solution or penalty, but a continuum of importance is provided. Thus, for some events, skipping that event is more grave if the item type of the event is higher in priority, or the event has many descendants that rely on that subject matter as a prerequisite, or both. This also is an event-specific penalty that applies to any event that does not fit into the framework at the end.

The next criterion is that of specific times required for particular events. Thus, as shown in step 112, the system evaluates events having preferred time specifications within the framework. If there is a specific time specified for a given item type, and an event of that type cannot meet it, then the number of shifts elapsed from the specific time affects the desirability of the solution. Further, certain types of events are specified at certain times. So, if the specific time is of the type “Beginning of Block”/“End of Block,” then the fitness of the solution is affected by the number of minutes elapsed since the specified point. A penalty is assessed by determining the actual start time from its scheduled start time.

The next criterion utilized by the system to determine the optimal schedule is that of determining frequency. When a frequency is specified for an item type, then an event of that type should be done that many times in the given interval. If this is not strictly met, then the number of occurrences from the given value will determine the loss of fitness to the solution. Also, if the item type is not occurring often enough, this incurs a greater penalty than if it is occurring too often. Thus, in step 114, the system evaluates events having a frequency greater than one in determining the best solution for the schedule.

The system utilizes data structures that serve as counters to keep track of the number of occurrences of each item type for each time period. This count is then used to assess penalties where necessary. At the end of each period, the counters would be reset.

The next criterion utilized in optimizing for the best schedule possible is that of determining acceptable rotation between shifts, which is illustrated in step 116. Certain items types are rotated between the shifts in a semi-regular pattern. When this criterion is chosen, the number of occurrences in each shift should be about the same throughout; when it does not, the solution incurs a penalty based on the difference in distribution among shifts over any time period. For example, if the morning shift teaches a certain item type six times in the first few days, but the other shifts only teach it four times in the same period, then a penalty value of one is incurred. If the morning shift teaches seven times and the others only four, then a penalty value of two is incurred. The penalties are determined based upon the significance of the events to be rotated and can be either more or less than the values given by way of example.

A running total array is provided in one exemplary embodiment to keep track of the different shifts for each item. At the end of the day within the schedule, if the distance between the largest and the smallest event were greater than two, then a penalty would occur. For each item type, an array keeps track of how many events occurred in each shift. It finds the difference in events between all shifts (AM & PM, AM & EVE, PM & EVE). then it uses the maximum of the differences to calculate a penalty.

The system, as shown in block 1 18, performs evaluation based on the criterion of event skipping. If an event must be skipped, then it is preferred that the event not be as important as another event. For example, a prerequisite event would be more important than a typical non-prerequisite event or an event weighted less significantly than another event. Thus, skipping the lower-rated event optimizes the schedule by incurring a lesser penalty.

The next criterion utilized in the system for determining optimization is that of mutual exclusion. Selected items types should not occur within a given interval along with another item type. When this rule is broken, then the number of offending events adversely affects the overall fitness of the solution. The offending item type is the one that has the lowest dominance. Dominance is defined by the item type priority multiplied by the number of its events in that time period. Item type priority is established by the operator and is based on the significance of the event to be presented.

To track mutual exclusion, a list of the most recent times of any event of each item type is maintained. When an event is scheduled, the list is checked to determine if an excluded event has occurred within the excluded period. Accordingly, in step 120, the system evaluates events that are to be excluded from a given time slot in order to perform schedule optimization. Any penalties that are not event specific count against the schedule as a whole. These penalties, however, are not taken into consideration when populating the event list for bad events to be scheduled.

Once the various criteria have been reviewed and analyzed, the system, as shown in step 122, prepares an initial schedule and calculates optimization values for that particular schedule. Should the optimization value be insufficient, or in the attempt to improve upon the scheduling optimization value, the system may repeat step 122 after performing step 124. Step 124 involves conducting event swaps to improve schedule and optimization value.

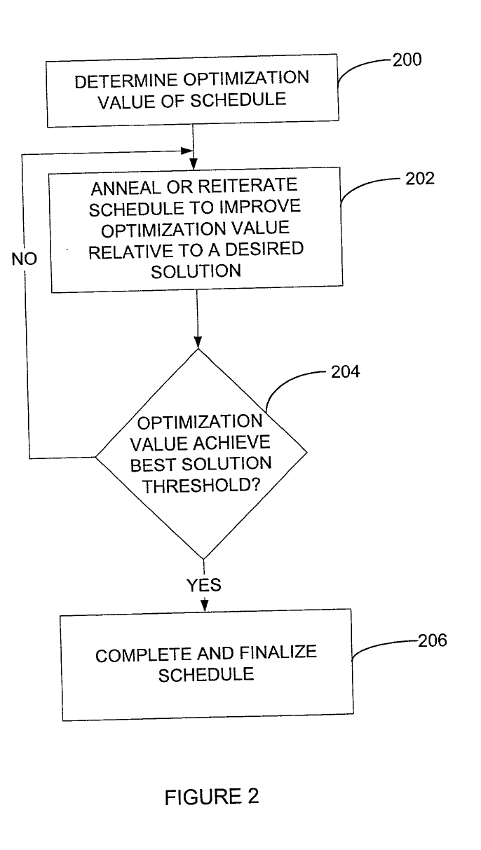

A significant element of the present invention is that of improving upon the original schedule as determined by the system. This improvement is also known as annealing the system to correct for defects originally found. The annealing operation, which is illustrated in the flow diagram of FIG. 2, reviews at least one of the following items: fluctuation number, fluctuation boundary, event swapping, bad list, and cooling schedule. The system initially determines the optimization value of the schedule, shown in block 200 and illustrated in FIG. 1. Next, the system performs the annealing operation using reiterative schedule evaluation and improvement, shown in block 202. The system then determines whether the annealed optimization value achieves the best solution threshold as shown in block 204. If yes, the system finalizes the schedule as shown in block 206; otherwise, the system repeats blocks 204 and 206 until the threshold is reached.

The fluctuation value of determining the optimal schedule is the amount of change from the first fluctuation to the current fluctuation and then to a succeeding fluctuation, all relative to the optimal or threshold value. The number of fluctuations during an iteration decreases as a function of the temperature of the system. The maximum number of swaps that are made is nr(t), where n is the number of events in a group and on r(t) is a special function that returns a number between and among zero (0) and one (1) where the return is a function of the temperature.

The fluctuation boundary is the boundary in which the optimal schedule value or the actual schedule value is allowed to fall between iterations. During any given iteration, fluctuations are contained to a certain part of the group. When the system first starts reviewing optimal schedules, the boundary is very large and includes most of the schedule. As the system progresses, however, this boundary shrinks with the temperature. This shrinking is also controlled by r(t) where the width of the window in events is 2+(n−2)r(t) where n is again the number of events in the group. This boundary is enforced based on the type of event chosen. If a bad event is chosen, then the boundary will be a neighborhood around that event. If the event selected is randomly selected, then the boundary will be in a fixed location in the group.

The system then selects events to swap during optimization. To choose an event to swap, the system allows a certain degree of randomness to occur. The system, however, progresses to a point where randomness is less of a factor and an event that is causing a large penalty will be selected over an event causing a small penalty. The probability of choosing an “offending” event increases as the solution becomes more refined. The percent probability of choosing a random event is based on temperature where the temperature ranges from 100-0 and the percent probability of choosing from the bad list is 100 minus the random event (RE) percent (100−RE%).

The bad list for each group is populated with ten events that were causing the worst penalties in the schedule. This list may include more or fewer events as determined by select criteria established within the system by use of the operator or by those managing the events to be scheduled. In choosing between bad list events and random events, the choice is limited to a maximum of ten times in one exemplary embodiment, but other values are possible. After this maximum threshold value, whether it be five, ten, fifteen, only random events may be chosen.

Schedule cooling is based on the relative temperature of the schedule, which also serves as the optimization value of the current solution. The temperature is closely tied to the fitness of the current solution. As the fitness of the solution increases, the temperature decreases. The temperature, however, cannot decrease more than a given amount in one iteration. This is tempering, which is intended to prevent wide fluctuations in iterations to occur endlessly. The temperature is based on the fitness and is a value between 100 and 0. In one example, the temperature is not allowed to drop by more than one degree in each iteration value. Thus, if the temperature is at 75 to begin with and a preferred value of 30 determines the optimal schedule solution, then a total of 45 iterations will be necessary before a threshold value is reached.

r(t)=(t/100)RAND^{(10-trunk(t/10))}+((100−t)/100)RAND^{11-trunk(t/10))}

For t≧100, r(t)=RAND.

An example of implementation will now be given. In this example, it will be an example of providing help to directors who organize curriculum for all language teachers within a language training seminar. This system enables the directors to make schedule updates at any time as well. For each language, the director inputs the curriculum. This is done by entering each item of curriculum that occurs in a class, lab, or training resource center. For grammar, the director enters each grammar principle to be taught. For tasks, the director enters each task to be formed. For topic study, the director enters each topic to be studied. For example, if the topics were found in a religious-type organization, and the topic was Gospel Study, then each gospel topic to be studied would be entered.

For each type of curriculum entered by the director, the director names the activities that are used to teach it. The director also specifies the duration of each activity, the location of the activity, whether it be in a class, lab, or training resource center (TRC), or the like, priority, frequency, and other criteria, as well as any necessary delays between activities when needed.

Next, the director defines the relationships in the curriculum. This is also kept up to date for each language. To define the relationships, the director must specify which activities for a certain item must be covered before another related item can be taught. Any item can have any number of prerequisites.

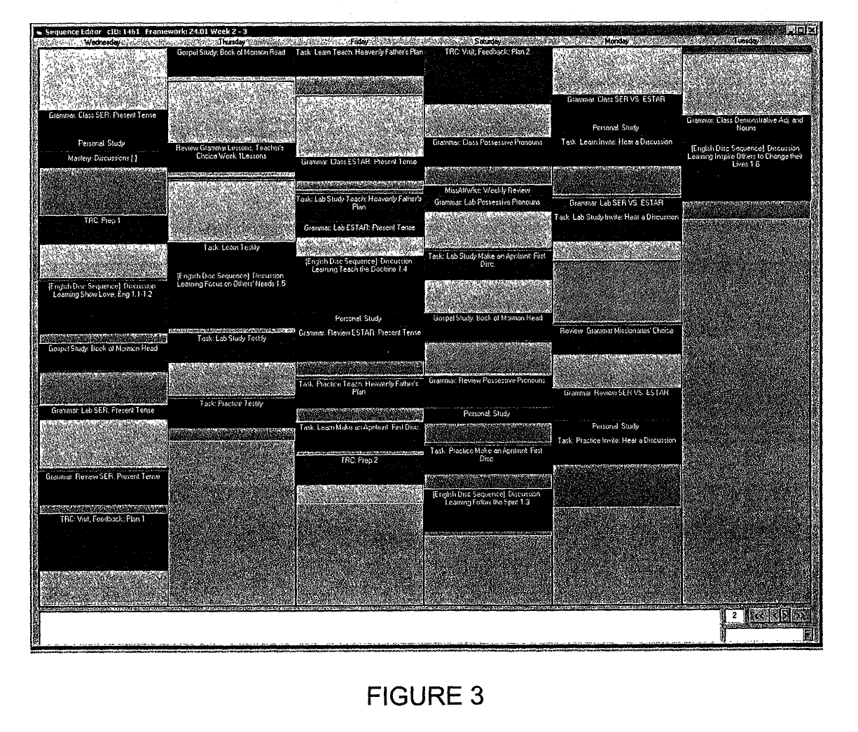

Next, the director fills a schedule with the curriculum. FIG. 3 illustrates a sample of a filled schedule in accordance with the present invention. First, the director places certain curriculum events as anchor points onto a framework schedule. After the anchor points have been established, the method and system of the present invention then takes the remaining items and activities and events and fills them within the schedule around these anchor points. Once the system has completed filling in the events, activities, and items as best possible, the system informs the director of blank spaces in classroom, lab, or TRC schedule blocks. Also, the program lists the curriculum that does not fit and shows the percent of time spent in each area of curriculum. After the system has performed its initial iteration, the director is given the opportunity to make adjustments by changing curriculum input or defining relationships, or both, before the system performs a reiteration of best solution optimization. By default, it will continue to iterate.

Once this is completed, the schedule is revised in such a way as to indicate what curriculum should occur in each class, lab, and TRC session. Once the schedule has been completed, it may then be saved, viewed, or printed, or any combination of the three. A list of framework locations is typically made available to the directors. These locations found on the list will include such options as class, lab, TRC, personal study, referral center, and group or partnership study.

The schedule provided typically is assigned to each student or participant within that particular language group in keeping with the example presented. A larger schedule for the facility may also be provided where each language group will be scheduled in parallel tracks to one another.

The director or facility coordinator typically sets global criteria for several languages at once. This allows for the criteria for certain item types to be locked in certain languages. For example, reading time of particular material every afternoon can be entered at the administrative level, and as such, can only be removed at the administrative level. The system may also take into account particular holidays, general events, and other selected general anchor points for use within the framework schedule. These general anchor points may fall on a particular day on a quarterly, monthly, semi-annually, or other defined time frame basis.

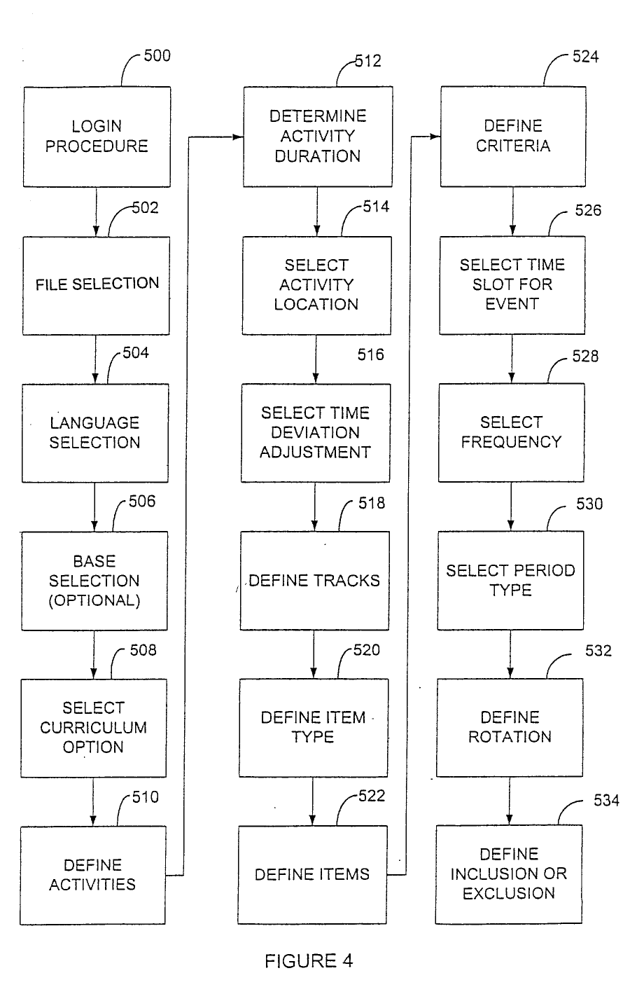

A more in-depth discussion of how a user would prepare a schedule and how the system performs the automatic scheduling of remaining events will now be given. FIG. 4 illustrates a flow diagram of the steps typically performed by the user and selected steps that are performed automatically by the system in preparing a schedule. Initially, as shown in block 500, a log-in procedure is performed where the user logs into the system and then is presented with a choice of file options. The user, as shown in block 502, makes a files selection, such as either selecting a new organization or a previously defined organization. When a new organization is selected, the user is queried as to whether to add a particular base to the organization. This may be an optional feature and selected or de-selected at the administrator's discretion.

It should be understood that there are hierarchal rights that can be provided to particular set elements within the system. For example, bases are locked so only particular individuals who have clearance or who are the authors of such bases can modify them. Thus, if the individual that wants to make changes within a particular schedule lacks clearance to perform such changes, then no changes will be made. Further, if the user does have clearance, a reminder that such changes will affect the entire organization will be provided to the user in order to avoid inadvertent changes. Also, the user will be able to set dates of applicability for any new organization or even to modify any previous organization saved.

Language selection is made next. If the user desires the schedule to be specific to a particular language, the user then selects the particular language from the option menu. This is shown in block 504. Upon selection of the language, a list of languages will appear and the user then chooses the appropriate language or no specific language if the schedule is not to be language specific.

The user next makes selection of a base or organization, shown in block 506. The user has the option of selecting among three different areas. These areas include input curriculum, define relationships, and fill/view/print at any time. A base is an organization that is used by another organization. The parent organization is made available through the base in a read only format. In order to edit the parent, the user needs to exit the base and enter the parent organization directly. If a base is changed, those changes will affect all organizations using that base.

When the user selects the main input curriculum option (block 508), a graphical user interface (GUI) will be displayed and will include standard options within such GUI environment, such as a list box and a space for entry or selection. The list box will typically include activities, delays, tracks, criteria, item types, and items. Once the user chooses an option from the list box, the GUI will display an area that corresponds with the entry and will include such elements as duration, deviation of duration, and location. For example, if the user selects “activities” from the list box, a “define activities” interface appears within a GUI area on the screen to enable the user to define such activities.

In defining activities, as shown in block 510, the user enters an activity name. Next, as shown in block 512, the user determines the duration range (max & min) of the activity by either entering a time or by selecting it with particular arrows. Typically, the default time is set at zero so if the user fails to enter a time, a warning message will indicate such and invite the user to provide such a time before exiting. Next, as shown in block 514, the user selects the particular location for the activity to take place. To avoid confusion, it is helpful to prevent duplicate names from being created. Thus, if a duplicate name is entered, a warning will appear notifying the user of such duplication and requesting a new name be entered.

Once the activity is defined, then the user is provided the opportunity to define allowed delays. A GUI screen will typically be provided to the user where the user can define the delay by name, establish the period for such delay, and what type of period. Thus, the period can be for or until next and the type of period can be for a shift, day, week, or location.

Next, as shown in block 518, the user then defines tracks. The user defines a track sequence where appropriate.

Next, as shown in block 520, the user begins defining item types. A GUI screen allows the user to create new item types. A list of criteria is provided to the user. The user selects from the criteria for defining an item type. First, the user selects a particular item type and all the criteria specified for that item type are then highlighted. A list of report categories are also provided, which typically are static. The user can select multiple report categories, but is not allowed to create new ones at this stage. Each time an item type is selected, the report categories appropriate for that item type are listed. Further, the user is able to assign a priority, such as high, medium, or low, to the item type selected. Other types of priority are possible, such as a numerical scale of one to ten or other selected scales defined by the system developer.

The system then proceeds to block 522, which allows the user to define items. Items are defined by giving a name or selecting from previously defined items and the item type associated with the item is also defined. Further, the user may select the duration range for the particular item.

Next, as shown in block 524, the user defines criteria. The user defines the criterion by type and then by name. The type listed included specific time, frequency, rotation between shifts, or mutual exclusion. Once the user has completed the criteria definition, the system then proceeds to block 526.

In block 526, the user selects a specific time slot for a given event. Initially, the user selects a type of specific time for the event. This can be either a fixed time, start time for a range, or end time for a range. For example, a fixed time selection can be for “during week 6,” once the user has selected the time, the user then selects the period of time for the event. The user then specifies which week, day of the week, or shift the event in question shall occupy. Next, the type of period selection is made from the offered options.

Next, the user, as shown in block 528, selects the frequency for a given event. First, the user selects the frequency type, such as exact, maximum (at most ______), or minimum (at least ______). Next, the user selects the type of period, shown in block 530, which includes per week, per day, per shift, or per location. The locations can include classroom, lab, TRC, or others. Next, the user enters the frequency number in a particular box. For example, if three (3) is entered, that would signify three times per week, if the type of period is per week.

Next, the user has the option of defining whether rotation is necessary between shifts, as illustrated in block 532. If a particular event requires rotation between shifts, the user selects the frequency that the event will be rotated. The rotation may be either daily or weekly or any other frequency desired and the user establishes which shift starts. The start shift may be at any time, a morning, an afternoon, or evening, or any other appropriate schedule provided.

Next, as shown in block 534, the user has the option of defining whether certain item types are mutually inclusive or exclusive. This means certain item types may or may not be taught during the same shift, day, or week. First, the user selects the item type that cannot be used with other item types, and then selects the period of time from which that item will be excluded. Once the mutual exclusion or inclusion is provided, the user has completed the initial curriculum organization and is then given the opportunity to define relationships.

The procedure for defining relationships is now presented. The user selects the define relationships tab within the GUI and a screen is displayed showing relationships between items in terms of the order in which they are taught to the students or participants. Should a user select a particular item, the prerequisite items will be displayed related to the particular item. Optionally, the user may select the post requisite items for that particular item and those items will be displayed. The user adds items to the prerequisite and post-requisite columns by dragging an item from one location to the left or right of that column or into the particular columns for either prerequisites or post-requisites. Once the prerequisites and post-requisites are defined, the schedule is now ready to be completed and then viewed. The user selects the fill/view/print tab and options such as fill, print, or view are performed. For example, when the user clicks the fill button, the schedule fills in with curriculum as shown in FIG. 3. The user then chooses a specific item type and item, which allows the user to select any activity from the activity list and place it as an anchor, or a point. Anchoring points typically are depicted on the schedule in bold face or a defined color to distinguish them from other events.

In the event there are errors occurring within the filled schedule, an error log is created for that framework. An error occurs whenever the system, while filling the schedule, cannot place an item or if there is ever more than fifteen (15) unused minutes in any given day. The error may be defined to allow more unused minutes for a given day depending upon the developer's constraints. Also, every violation of criteria is reported in this error log.

Optionally, the system allows various reports to be generated. Two such reports are now provided. The first report is that of users of the curriculum organizer. This report provides information that would help the director or user to build and make sense of the view of the schedule. Another report provides information regarding curriculum hours distribution. For example, given the present allowable time range of each activity in the curriculum, the report may list the maximum and minimum possible total duration of each item type. Another report may list the maximum and minimum possible duration of a set of curriculum. This would allow an evaluation of whether a set of curriculum mght fit within a given framework.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A method for generating a schedule that is filled with a plurality of events, comprising:
defining a framework to serve as the schedule and to be populated with the plurality of events, the framework to define periods of time and days to be populated;
inserting at least one immutable event selected from the plurality of events within the framework;
populating the framework with the remaining plurality of events;
determining whether selected of the remaining plurality of events can populate the framework without conflict within the periods of time and days to be populated;
adjusting a time value for a given event that cannot fit within the framework at a selected time and day period until the given event fits within the framework;
determining delays allowed between selected of the plurality of events;
allocating the allowed delays to optimize the schedule;
evaluating selected of the plurality of events having preferred time specifications;
allocating the selected plurality of events based on their preferred time specifications;
calculating an optimization value based on preferred time conflicts, delay conflicts, or time or day period conflicts among the plurality of events;
determining whether the optimization value achieves a threshold best-solution value; and
performing event swapping of the plurality of events to improve the optimization value until achieving the best-solution threshold value.

2. The method according to claim 1 further comprising the steps of:
determining relationships between events placed within the framework; reevaluating the optimization value based on the event relationships.

3. The method according to claim 1 further comprising determining the optimization value based on events that have a frequency greater than one.

4. The method according to claim 1 further comprising determining the optimization value based on events that are to be excluded.

5. A computerized system for optimizing a schedule that is filled with a plurality of events, comprising:
means for defining a framework to serve as the schedule and to populate the framework with the plurality of events, selected of the plurality of events being immutable; and
means for determining an optimization value based on the placement of the plurality of events after placement of the immutable events and for determining whether the optimization value achieves a threshold best-solution value.

6. The scheduling system according to claim 5 wherein the framework defining means can also perform event swapping to improve the optimization value.

7. The scheduling system according to claim 5 wherein the framework defining means determines whether selected of the remaining plurality of events can populate the framework without conflict within the periods of time and days to be populated.

8. The scheduling system according to claim 5 wherein the framework defining means adjusts a time value for a given event that cannot fit within the framework at a selected time and day period until the given event fits within the framework.

9. The scheduling system according to claim 5 wherein the framework defining means determines delays allowed between selected of the plurality of events and allocates the allowed delays to optimize the schedule.

10. The scheduling system according to claim 5 wherein the framework defining means evaluates selected of the plurality of events having preferred time specifications and allocates the selected plurality of events based on their preferred time specifications.

11. The scheduling system according to claim 5 wherein the optimization determination means calculates the optimization value based on preferred time conflicts, delay conflicts, or time or day period conflicts among the plurality of events populated within the framework or excluded therefrom.

12. The scheduling system according to claim 5 wherein the framework defining means determines relationships between events placed within the framework and the optimization determination means reevaluates the optimization value based on the event relationships.

13. A computer program product for optimizing a schedule filled with a plurality of events, said computer program comprising code that directs a computer to:
defining a framework to serve as the schedule and to be populated with the plurality of events, the framework to define periods of time and days to be populated;
inserting at least one immutable event selected from the plurality of events within the framework;
populating the framework with the remaining plurality of events;
determining whether selected of the remaining plurality of events can populate the framework without conflict within the periods of time and days to be populated;
adjusting a time value for a given event that cannot fit within the framework at a selected time and day period until the given event fits within the framework;
determining delays allowed between selected of the plurality of events;
allocating the allowed delays to optimize the schedule;
evaluating selected of the plurality of events having preferred time specifications;
allocating the selected plurality of events based on their preferred time specifications;
calculating an optimization value based on preferred time conflicts, delay conflicts, or time or day period conflicts among the plurality of events;
determining whether the optimization value achieves a threshold best-solution value; and
performing event swapping of the plurality of events to improve the optimization value until achieving the best-solution threshold value.

14. The method according to claim 13, further comprising the steps of: determining relationships between events placed within the framework; reevaluating the optimization value based on the event relationships.

15. The method according to claim 13, further comprising determining the optimization value based on events that have a frequency greater than one.

16. The method according to claim 13, further comprising determining the optimization value based on events that are to be excluded.
